(19) United States
(12) Patent Application Publication
(10) Pub. No.: US 2008/0231715 A1
(43) Pub. Date: Sep. 25, 2008

(54) IMAGE TAKING APPARATUS

(76) Inventor: Hiroshi ENDO, Asaka (JP)

Correspondence Address: BIRCH STEWART KOLASCH & BIRCH, PO BOX 747, FALLS CHURCH, VA, 22040-0747, US

(21) Appl. No.: 11/971,724

(22) Filed: Jan. 9, 2008

(30) Foreign Application Priority Data
Mar. 23, 2007 (JP) 2007-076821

(51) Int. Cl. H04N 5/228; H04N 5/225; G06K 9/00

(52) U.S. Cl. 348/208.99; 348/207.99; 382/118; 348/E05.024; 348/E05.031

(57) ABSTRACT

There is prepared an image sensor capable of creating an image of 300 frames per second. The image sensor creates consecutively images so that the digital signal processing section 182 generates a piled up image. When the face detection section 190 detects a face, the digital signal processing section 182 regards the main subject as person and generates a piled up image while positioning for the faces, so that the subject shake is corrected. When the face detection section 190 detects no face, the digital signal processing section 182 generates a piled up image in accordance with the blurring detection state of the angular velocity sensor, so that the camera shake is corrected.

### BACKGROUND OF THE INVENTION

1. Field of the Invention

The present invention relates to an image taking apparatus having an imaging device or an image sensor, which forms an image of a subject on the imaging device to create image data representative of the subject.

2. Description of the Related Art

Hitherto, there is proposed a technology wherein a movement vector representative of the movement of two or more images is determined in accordance with those two or more images to correct the camera shake (for instance, refer to Japanese Patent Application Laid Open Gazette TokuKai Hei. 11-252445, and Japanese Patent Application Laid Open Gazette TokuKai 2006-262220). However, according to the technology disclosed in those Japanese patent documents, it is difficult to correct the subject shake. More in details, in the event that when the subject is divided into the main subject and the background, only the main subject moves, blurring of the main subject cannot be corrected.

By the way, it is reported to have succeeded in the development of the image sensor that is able to generate frames of the number of 300 pieces a minute with 1.2M (1.2 mega pixels) recently. The use of such an image sensor makes it possible to obtain many images, that is, pieces a second by raising the frame rate. Thus, piling up the image of each frame makes it possible to raise the S/N ratio so that high definition of still picture photography can be obtained. And not only the camera shake, as reported in the specification of Japanese Patent Application Laid Open Gazette TokuKai Hei. 6-284327, but also the subject shake can be corrected some degree.

However, even in case of the image taking apparatus to which the technology of Japanese Patent Application Laid Open Gazette TokuKai Hei. 6-284327 is applied, the image of each frame shifts slightly when the subject moves when the portrait photography is done for instance, and it is overlapped, so that the image that the person and the background are both blurred might be obtained.

By the way, there is proposed the technology in which a face is detected by the face detection means, and the detected face is clearly caught and is displayed with the expansion (Refer to Japanese Patent Application Laid Open Gazette TokuKai 2005-102175). When the face is detected by using the technology of Japanese Patent Application Laid Open Gazette TokuKai 2005-102175, the main subject at the time of taking a picture can be easily identified.

### SUMMARY OF THE INVENTION

In view of the foregoing, it is an object of the present invention to provide an image taking apparatus capable of solving the problem of the subject shake as mentioned above, and particularly of correcting the subject shake where the main subject is a person.

To achieve the above-mentioned objects, the present invention provides an image taking apparatus that images a subject on an imaging device to create an image representative of the subject, the image taking apparatus including:

multi-page means that performs two or more consecutive shootings to create two or more images;

piled up image creating means that creates a piled up image by piling up the images obtained by the multi-page means; and

face detection means that detects a face in each of the two or more images,

wherein the piled up image creating means performs mutually positioning of the faces detected by the face detection means in the two or more images through the two or more images, and piles up the two or more images to create the piled up image.

According to the image taking apparatus of the present invention as mentioned above, the piled up image creating means performs positioning of the faces of said two or more images detected by the face detection means through said two or more images, and creates the piled up image by piling up said two or more images. This feature makes it correct the subject shake in such a way that the person is regarded as the main subject in the state that the face detection means detects the face.

In the image taking apparatus according to the present invention as mentioned above, it is preferable that the image taking apparatus further includes camera shake detection means that detects a camera shake to create camera shake information for each of the two or more consecutive shooting by the multi-page means,

wherein when the face detection means detects no face in the two or more images, the piled up image creating means performs mutually positioning through the two or more images in accordance with the camera shake information created by the camera shake detection means, and piles up the two or more images to create the piled up image.

According to the image taking apparatus of the present invention as mentioned above, the piled up image creating means performs positioning through said two or more images in accordance with the camera shake information created by the camera shake detection means, when the face detection means detects no faces of said two or more images, and creates the piled up image by piling up said two or more images. In other words, when the face detection means detects no faces, the main subject is regarded as the scenery and the camera shake is corrected.

In the image taking apparatus according to the present invention as mentioned above, it is acceptable that the camera shake detection means is an angular velocity sensor.

In the image taking apparatus according to the present invention as mentioned above, it is acceptable that the image taking apparatus further includes movement vector computing means that computes a movement vector representative of movements of the two or more images in accordance with the two or more images,

wherein when the face detection means detects no face in the two or more images, the piled up image creating means performs mutually positioning through the two or more images in accordance with the movement vector computed by the movement vector computing means, and piles up the two or more images to create the piled up image.

According to the image taking apparatus of the present invention as mentioned above, it is possible to correct the camera shake in such a way that the piled up image creating means performs positioning through said two or more images in accordance with the movement vector computed by the movement vector computing means, when the face detection means detects no faces of said two or more images, and creates the piled up image by piling up said two or more images.

To achieve the above-mentioned objects, the present invention provides an image taking apparatus that images a subject on an imaging device to create an image representative of the subject, the image taking apparatus including:

multi-page means that performs two or more consecutive shootings to create two or more images;

piled up image creating means that creates a piled up image by piling up the images obtained with the multi-page means;

face detection means that detects a face in each of the two or more images;

camera shake detection means that detects a camera shake to create camera shake information for each of the two or more consecutive shootings by the multi-page means, and

mode switching means that switches, when the piled up image creating means creates the piled up image, a mode between a first mode in which the face detection means is prioritized and a second mode in which the camera shake detection means is used,

wherein in a case the face detection means detects a face in the two or more images in the first mode, the piled up image creating means performs mutually positioning the face in each of the two or more images through the two or more images and piles up the two or more images to create the piled up image, and in a case where in the first mode the face detection means detects no face in the two or more images or in the second mode, the piled up image creating means performs mutually positioning through the two or more images in accordance with the camera shake information created by the camera shake detection means, and piles up the two or more images to create the piled up image.

According to the image taking apparatus of the present invention as mentioned above, the photographer's operation of the mode switching means makes it possible for the image taking apparatus to instruct which one is to be corrected with priority between the subject shake and the camera shake.

In the image taking apparatus according to the present invention as mentioned above, it is preferable that the image taking apparatus further includes mode notification means that notifies a user of whether the image taking apparatus is currently in the first mode or the second mode.

This feature makes it possible for a user to confirm on the display screen as to which one mode is switched by the mode switching means.

In the image taking apparatus according to the present invention as mentioned above, it is acceptable that the first mode is a camera shake correction mode for correcting a camera shake, and the second mode is a subject shake correction mode for correcting a subject shake.

In the image taking apparatus according to the present invention as mentioned above, it is acceptable that the first mode is a scenery shooting mode for taking a picture of scenery, and the second mode is a self shooting mode that takes a picture of oneself.

In the image taking apparatus according to the present invention as mentioned above, it is acceptable that the camera shake detection means is an angular velocity sensor.

In the image taking apparatus according to the present invention as mentioned above, it is acceptable that the camera shake detection means is a movement vector computing means.

To achieve the above-mentioned objects, the present invention provides an image taking apparatus that images a subject on an imaging device to create an image representative of the subject, the image taking apparatus including:

multi-page means that performs two or more consecutive shootings to create two or more images;

piled up image creating means that creates a piled up image by piling up the images obtained by the multi-page means;

face detection means that detects a face in each of the two or more images;

movement vector computing means that computes a movement vector representative of movements of the two or more images in accordance with said two or more images; and

mode switching means that switches, when the piled up image creating means creates the piled up image, a mode between a first mode in which the face detection means is made to give priority and a third mode in which the movement vector computing means is used,

wherein in a case the face detection means detects a face in the two or more images in the first mode, the piled up image creating means performs mutually positioning the face in each of the two or more images through the two or more images and piles up the two or more images to create the piled up image, and in a case where in the first mode the face detection means detects no face in the two or more images or in the third mode, the piled up image creating means performs mutually positioning through the two or more images in accordance with the movement vector computed by the movement vector computing means, and piles up the two or more images to create the piled up image.

In the image taking apparatus according to the present invention as mentioned above, it is preferable the image taking apparatus further includes mode notification means that notifies a user of whether the image taking apparatus is currently in the first mode or the third mode.

In the image taking apparatus according to the present invention as mentioned above, it is acceptable that the first mode is a camera shake correction mode for correcting a camera shake, and the third mode is a subject shake correction mode for correcting a subject shake.

### BRIEF DESCRIPTION OF THE DRAWINGS

FIG. 1 is a perspective view of a digital camera, which is one embodiment an image taking apparatus of the present invention.

FIG. 2 is a functional block diagram of the electrical system of the digital camera 100 of FIG. 1.

FIG. 3 is a flowchart useful for understanding procedure of image taking processing of the microcomputer 110.

FIG. 4 is a functional block diagram of a digital camera 100A, in which a movement vector computing section is added to a digital signal processing section 182A.

FIG. 5 is a flowchart useful for understanding procedure of image taking processing of the microcomputer 110 of a digital camera 100A of FIG. 4.

FIG. 6 is a flowchart useful for understanding procedure of image taking processing of the microcomputer 110 where there is provided mode setting means for setting either one of the subject shake correction mode and the is camera shake correction mode.

FIG. 7 is a flowchart useful for understanding another processing procedure where there is provided mode setting means which is the same as FIG. 6.

FIG. 8 is a flowchart useful for understanding processing procedure where the camera shake is corrected at the scenery mode and the subject shake is corrected at the portrait mode.

FIG. 9 is a flowchart useful for understanding another processing procedure in the same structure as FIG. 8.

FIG. 10 is a flowchart in a structure wherein the photographer is notified of the correction mode in such a way that the image indicative of a matter that the subject shake is corrected is displayed on the display screen.

FIG. 11 is an explanatory view useful for understanding a camera shake correction mark.

FIG. 12 is a flowchart useful for understanding processing procedure where a correction mode is recorded onto a tag area of Exif file that is an image file.

FIG. 13 is an explanatory view useful for understanding a memory allocation of Exif file.

### DETAILED DESCRIPTION OF THE INVENTION

Embodiments of the present invention will be described with reference to the accompanying drawings.

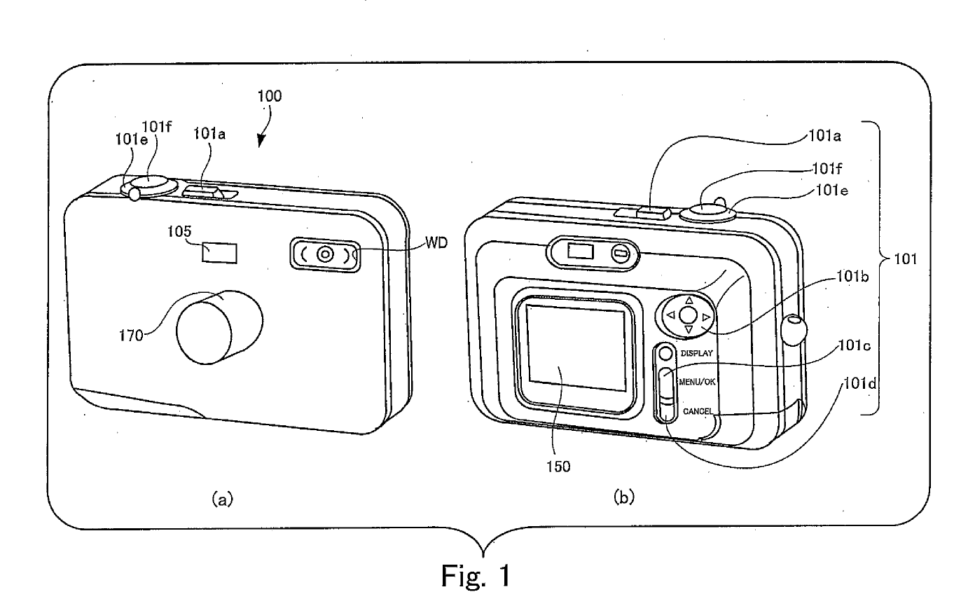

FIG. 1 is a perspective view of a digital camera, which is one embodiment an image taking apparatus of the present invention.

FIG. 1 shows a perspective view of a digital camera 100 of an embodiment of the present invention. A part (a) of FIG. 1 shows a perspective view of the digital camera 100 looking from the upper side of the front. A part (b) of FIG. 1 shows a perspective view of the digital camera 100 looking from the upper side of the back.

As seen from the part (a) of FIG. 1, the digital camera 100 has a lens barrel 170 at the center of the body of the camera, and a viewfinder 105 at the upper side of the lens barrel 170. A photography auxiliary light luminescence window WD is prepared for sideward of the viewfinder 105.

As seen from the part (b) of FIG. 1, at the back side and the upper side of the digital camera 100, there is prepared a handler group 101 of doing various operations when a user uses the digital camera 100.

The handler group 101 includes a power supply switch 101a to operate the digital camera 100, a cross key 101b, a menu/OK key 101c, a cancellation key 101d, and a mode lever 101e. The mode lever 101e serves to switch between a reproduction mode and a shooting mode, and further serves to switch between an animation mode and a still picture mode in the shooting mode. In the still picture mode, it is permitted to switch between a single-page and a multi-page. When the power supply switch 101a turns on in a state that the mode lever 101e is switched to the shooting mode, a through picture is displayed on a display screen 150. Taking a picture of the subject is carried out when a release button 101f is depressed while seeing the through picture at the shutter chance. In the multi-page mode, the release button 101f offers the toggle operation in which when the release button 101f is depressed once, the multi-page starts, and when the release button is depressed again, the multi-page ends. In the state that the mode lever 101e is switched to a reproduction side, a photographic image is subjected to a reproduction display on the display screen 150.

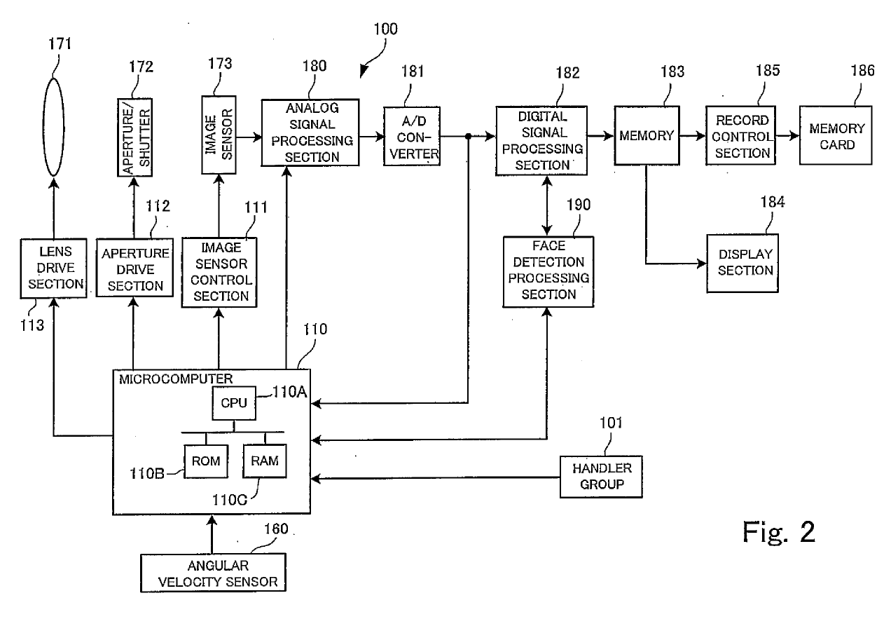

FIG. 2 is a functional block diagram of the electrical system of the digital camera 100 of FIG. 1.

With reference to FIG. 2, an inside structure and operations of the digital camera 100 will be briefly described.

The digital camera 100 is controlled in all processing by a microcomputer 110. The microcomputer 110 comprises a CPU 110A, a ROM 110B which serves as a program memory, and a RAM 110C used as a work area when processing is carried out in accordance with the program stored in the program memory.

First of all, there will be explained the structure on the periphery of the microcomputer 110.

An input section of the microcomputer 110 may receive operative signals from the handler group 101 shown in the part (b) of FIG. 1. When the input section of the microcomputer 110 receives at least one of the operative signals, the microcomputer 110 executes the processing according to the received operative signal. As mentioned above, the microcomputer 110 has the ROM 110B which serves as a program memory. The ROM 110B stores therein a program necessary so that the digital camera 100 may work as an image taking apparatus. The program stored in the ROM 110B runs when the power supply switch 101a is turned off, and waits for turning on of the power supply switch 101a. When the power supply switch 101a of the handler group 101 (cf. FIG. 1) turns on in this waiting state, the microcomputer 110 detects turn on of the power supply switch 101a, so that processing of controlling the movement of the digital camera according to the procedure of the program in the ROM 110a is begun. An electrical power is always supplied from a battery (not illustrated) to the microcomputer 110.

Hereinafter, there will be explained the operation of the digital camera 100 after the power supply switch 101a (Refer to FIG. 1) of the handler group 101 is turned on, referring to FIG. 2.

According to the digital camera 100, in the event that the power supply switch 101a turns on and the mode lever 101e is switched to the shooting mode, the through picture is displayed on the display screen 150. Accordingly, first of all, there will be explained processing for display of the through picture, and then there will be explained shooting processing to be carried out in response to depression of the release button 101f.

First of all, there will be explained processing where the through picture is displayed on the display screen 150.

When the microcomputer 110 detects the turn-on of the power supply switch 101a of the handler group 101, the electrical power is supplied from the battery to individual blocks. In the event that the mode lever 101e is switched to the shooting mode when the power supply switch 101a turns on, a signal that sets an electronic shutter and an image reading signal are supplied from an image sensor control section 111 to an image sensor 173 at prescribed intervals under the control of the microcomputer 110, and image signals are thinned out, so that the signals subjected to the thinning out are output from an image sensor 172 to an analog signal processing section 180 at prescribed intervals.

The analog signal processing section 180 performs reduction processing for noises and outputs the image signals subjected to the reduction processing for noises to an A/D converting section 181. The analog signal processing section 180 incorporates therein a variable gain amplifier of which a gain is set by the microcomputer 110 to adjust the sensitivity. The A/D converting section 181 receives an output signal of the analog signal processing section 180 and performs processing for conversion from an analog image signal to a digital image signal. The digital image signal is fed to a digital signal processing section 182 to perform signal processing for a conversion from RGB signals to YC signals. The image signal, which is subjected to the signal processing, is stored a memory 183 that serves as a buffer, so that a display section 184 performs a display on a display screen 150 in accordance with contents of the memory 183.

The image reading signal is supplied from the image sensor control section 111 to the image sensor 173 at prescribed intervals under the control of the microcomputer 110. Accordingly, whenever the contents of the memory 183 are rewritten at a predetermined timing, the image on the display screen 150 is switched so that an image, which is caught by a lens 171 of a lens barrel, is displayed on the display screen 150 in form of the through image.

When the through-image is displayed on the display screen 150, the microcomputer 110 receives the supply of the digital image signal output from the A/D converting section 181 and always performs the exposure adjustment and the focus adjustment. Upon receipt of the supply of the digital image signal output from the A/D converting section 181, the microcomputer 110 performs the multiplication processing in each pixel that composes a frame of images, and performs the photometry processing (hereinafter it is referred to as AE processing) and the in-focus detection processing (hereinafter it is referred to as AF processing). The microcomputer 110 instructs a lens drive section 113 to drive a focus lens 171 in the lens, and instructs an aperture drive section 112 to adjust the diameter of an aperture/shutter 172.

Thus, when the release button 101f is depressed where the through image adjusted in the exposure and the focus is displayed, the aperture/shutter 172 is driven in open by the aperture drive section 112 under control of the microcomputer 110 in synchronism with timing of depression of the release button 101f, so that the subject light is formed on the image sensor 173. After a predetermined time elapses and the aperture/shutter 172 is closed to operate, the image signals based on the subject light, which are formed on the image sensor 173, are all output to the analog signal processing section 180 in form of RGB signals. Upon receipt of the RGB signals, the analog signal processing section 180 performs noise reduction processing and the like, and supplies the image signals subjected to the noise reduction processing and the like to the A/D converting section 181. The image signals, which are converted into the digital signals in the A/D converting section 181, are supplied to the digital signal processing section 182 to perform processing for the conversion from the RGB signals to YC signals. The YC signals are temporarily stored in the memory 183. The YC signals stored in the memory 183 are compressed under control of a record control section 185. The compressed YC signals are recorded on a memory card 186 together with compression information in form of an image file.

According to the present embodiment, there is shown an example in which there is adopted the image sensor 173 that is capable of creating 300 frames a second, and there is provided a face detection processing section for detecting a position of the face of an image on individual frame of which it continuously takes a picture with the image sensor. In other words, according to the present embodiment, the image sensor 173 and the image sensor control section 111 constitute multi-page means referred to in the present invention.

The digital signal processing section 182 of the digital camera 1 according to the present embodiment has an image creation function of piling up images acquired with the multi-page means on each frame in accordance with the control of the microcomputer 110 so as to generate a piled up image. According to this example, in the state that a face detection processing section 190 detects a face, the digital signal processing section 182 generates the piled up image while suiting the position of the face under the control of the microcomputer 110. In other words, according to the present embodiment, the microcomputer 110 and the digital signal processing section 182 constitute image piling and creating means referred to in the present invention.

According to the present embodiment, there is provided an angular velocity sensor 160 which constitutes camera shake detection means. When no face is detected, the camera shake is corrected in accordance with camera shake information detected with the angular velocity sensor 160.

The above description is concerned with the structure of the digital camera 100 according to the present embodiment.

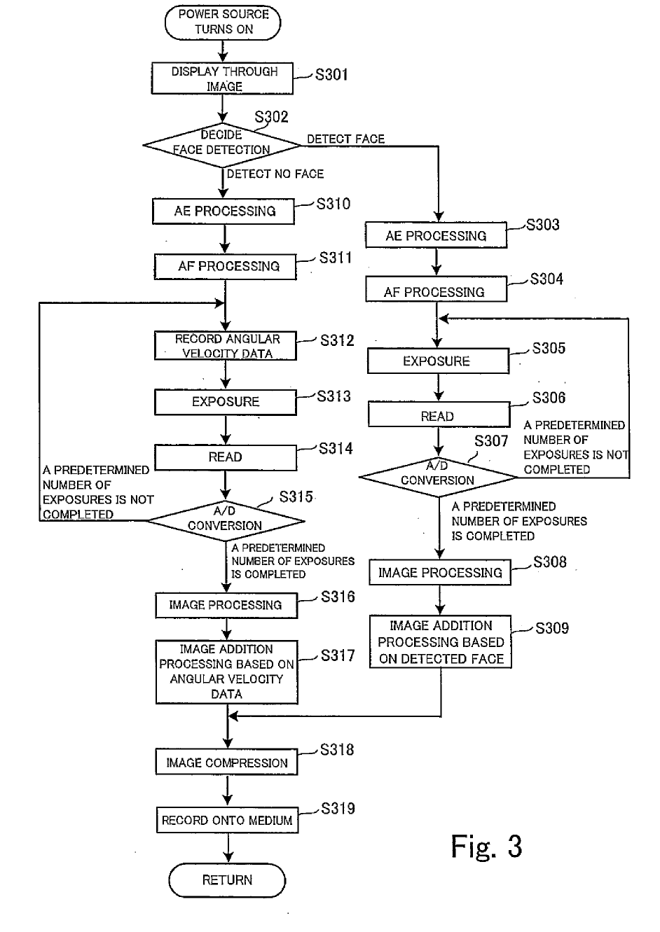

FIG. 3 is a flowchart useful for understanding procedure of image taking processing of the microcomputer 110.

When the power source turns on, processing of the flow starts. The flowchart of FIG. 3 will be explained assuming that a still picture is created in such a manner that taking a picture two or more times is continuously done when the release button 101f is depressed where the mode lever 101e is in the shooting mode, and the still picture mode in the shooting mode.

In a step S301, when the power source turns on, the through image is displayed on the display screen. When the release button 101f (cf. FIG. 1) is depressed on a half-depression basis, the face detection processing section 190 performs the face detection processing. In a step S302, it is decided whether a face is detected. When it is decided that a face is detected, the process goes to a step S303 in which the AE processing is performed. In a step S304, the AF processing is performed. In a step S305, the exposure onto the image sensor 173 is carried out by instructing the lens drive section 113 to drive the focus lens to the focusing position acquired with the AF processing and instructing the aperture drive section 112 to open-drive the aperture/shutter 172 in accordance with the exposure value computed through the AE processing. After a predetermined shutter time elapses, the aperture/shutter 172 is close-driven to terminate the exposure, and the program proceeds to a step S306. In the step S306, the image sensor 173 outputs an image to the analog signal processing section 180 by instructing the image sensor control section 111 to supply a read signal. In a step S307, the A/D converting section 181 performs A/D conversion to supply the digital signal to the digital signal processing section 182. In the step S307, it is judged whether a predetermined number of exposures for multi-page is performed. When it is decided that the predetermined number of exposures is not completed, the program returns to the step S305 to repeat the processing of the step S305 to the step S307. In the step S307, when it is decided that the predetermined number of exposures is completed, the program proceeds to a step S308. In the step S308, the digital signal processing section 182 performs image processing. Next, the program proceeds to a step S309. In the step S309, a piled up image is created through piling up two or more images which are detected with the face detection processing section 190 in such a manner that faces of said two or more images are subjected to mutually positioning through said two or more images so as to pile up said two or more images. In a step S318, the digital signal processing section 182 performs the compression processing. In a step S319, an image is recorded on the memory card 186. Thus, the processing is terminated.

On the other hand, in the step S302, when it is decided that the face detection processing section 190 detects no face of two or more images, the program proceeds to a step S310 in which AE processing is carried out. In a step S311, AF processing is carried out. In a step S312, an output result of the angular velocity sensor 160 is stored in a register. In a step S313, the aperture drive section 112 starts the exposure. After the exposure is terminated, the program goes to a step S 314 in which it instructs the image sensor control section 111 to supply the read signal to the image sensor 173 so that the image is read from the image sensor 173 to output to the analog signal processing section 180. In a step S315, the A/D converting section 181 performs the conversion into the image of the digital signal. In a step S316, the digital signal processing section 182 starts the image processing. In a step S317, the digital signal processing section 182 creates a piled up image through piling up two or more images in such a manner that said two or more images are subjected to mutually positioning through said two or more images in accordance with camera shake information stored in the register so as to pile up said two or more images. In the step S318, the digital signal processing section 182 performs the compression processing. In the step S319, an image is recorded on the memory card 186. Thus, the processing is terminated.

According to the execution of the above-mentioned processing by the microcomputer 110, when the face is detected, the digital signal processing section 182 corrects the subject shake through two or more images in accordance with the detection result of the face by the face detection processing section 190, and when the face is not detected, the digital signal processing section 182 corrects the camera shake in accordance with the camera shake information detected by the angular velocity sensor 160. Thus, it is discriminated by the image taking apparatus in accordance with the existence of the face whether the main subject is person or background. When it is decided that the main subject is person, the subject shake is corrected, and when the main subject is background, the camera shake is corrected.

As mentioned above, according to the present embodiment, it is possible to implement an image taking apparatus capable of correcting the subject shake when the main subject is person.

According to the present embodiment, the angular velocity sensor 160 is used. However, it is acceptable that the digital signal processing section 182 has a function of computing a movement vector without using the angular velocity sensor 160.

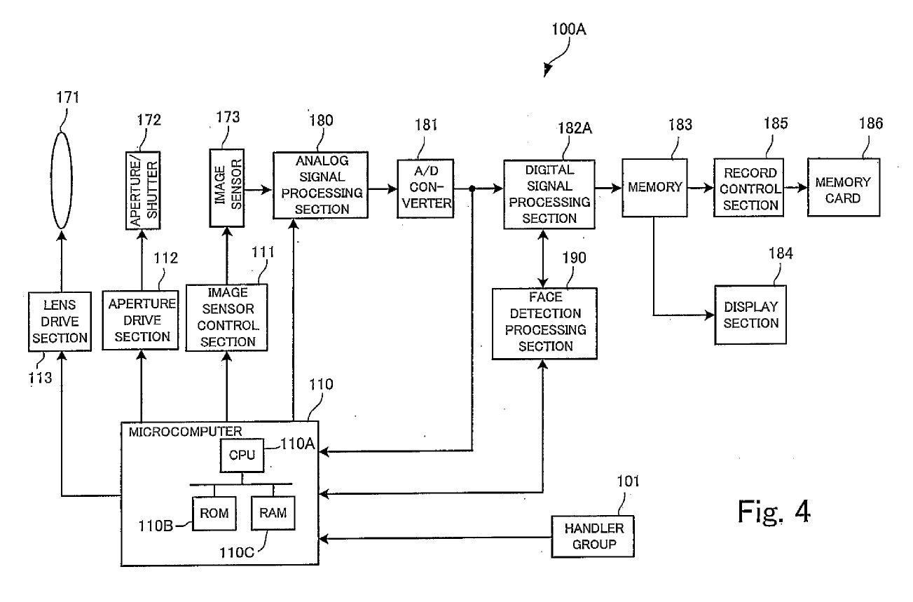

FIG. 4 is a functional block diagram of a digital camera 100A, which is identical to that of FIG. 2 excepting that the angular velocity sensor 160 is omitted, and a movement vector computing section is added to a digital signal processing section 182A.

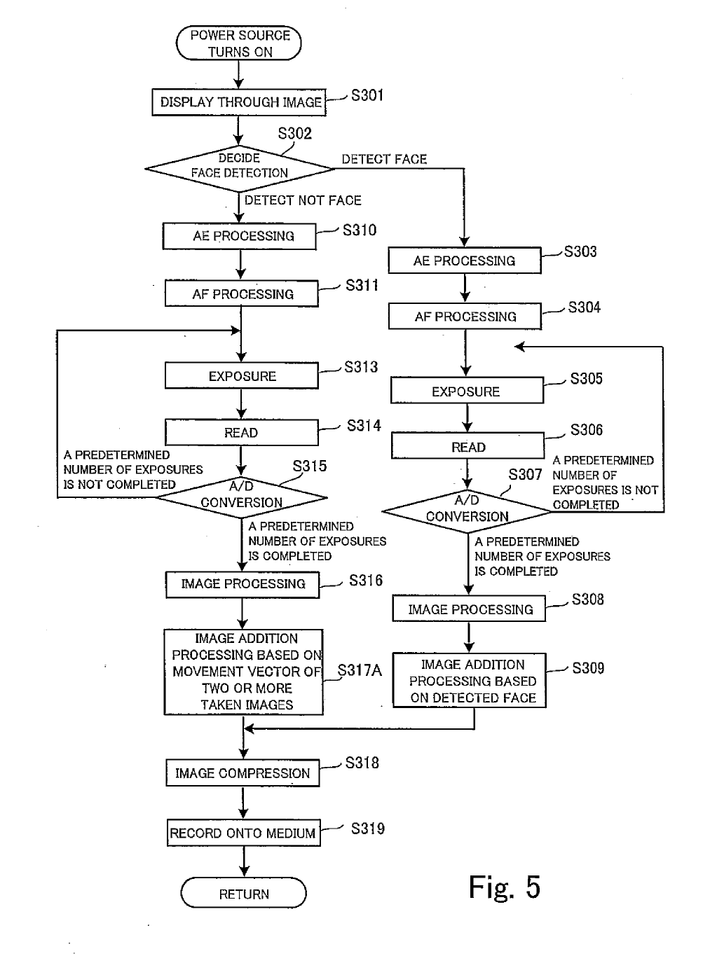

FIG. 5 is a flowchart useful for understanding procedure of image taking processing of the microcomputer 110 of the digital camera 101A of FIG. 4.

The image taking processing of the microcomputer 110 of the digital camera 100A is identical to that of FIG. 3 excepting that the processing of the step S312 in FIG. 3 is omitted, and the camera shake correction processing of the step S317 in FIG. 3 is replaced by the processing of a step S317A according to the movement vector that is computed by a movement vector computing section of a digital signal processing section 182A.

In other words, according to the present embodiment, it is acceptable that the movement vector computing means referred to in the present invention comprises the microcomputer 110 and the digital signal processing section 182.

According to the present embodiment, when the face is detected with the face detection processing section 190, the digital signal processing section 182 performs the correction of the subject shake while suiting the position of the face through two or more images, and when the face is not detected, the correction of the camera shake is performed in accordance with the camera shake information detected with the angular velocity sensor 160 or the blurring information computed by the movement vector computing section. However, it is acceptable that an operator selects through an operation a desired mode between the subject shake correction mode and the camera shake correction mode. In order to implement such a structure, it is effective to provide an arrangement for example in such a manner that when the menu/OK key 101c of FIG. 1 is operated so that the set screen for the blurring correction mode is displayed, the operation of the cross key 101b makes it possible to selectively designate the blurring correction mode between the camera shake correction and the subject shake correction mode.

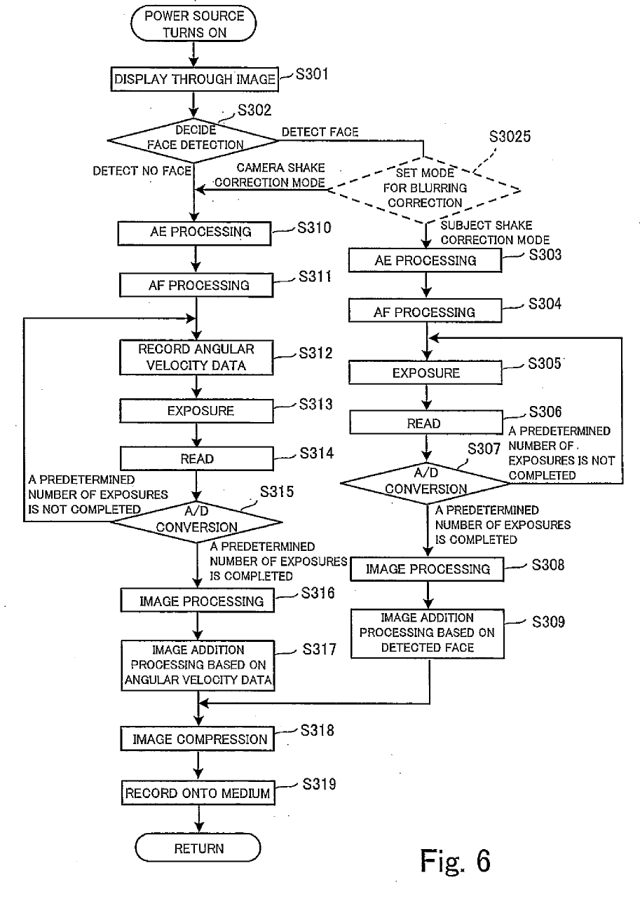

FIG. 6 is a flowchart useful for understanding procedure of image taking processing of the microcomputer 110 where there is provided mode setting means for setting either one of the subject shake correction mode and the camera shake correction mode.

The processing of the flowchart of FIG. 6 is identical to that of FIG. 3 excepting that a step S3025 is added to the processing of the flowchart of FIG. 3.

According to the processing of the flowchart of FIG. 3, when the face is detected, the digital signal processing section 182 performs the correction of the subject shake while suiting the position of the face through two or more images to generate the piling up image, and when the face is not detected, the correction of the camera shake is performed in accordance with the camera shake information detected with the angular velocity sensor 160. On the other hand, according to the embodiment of FIG. 6, even if the face is detected with the face detection processing section 190 in the step S302, the subject shake is corrected when it is decided in the step S3025 that the subject shake correction mode is designated, and the camera shake is corrected when it is decided in the step S3025 that the camera shake correction mode is designated.

In other words, according to the digital camera of the present embodiment, when a piled up image is created by the microcomputer 110 and the digital signal processing section 182, which constitute the piled up image creating means referred to in the present invention, there is provided the mode switching means for switching between a first mode in which it gives priority to the processing of the face detection processing section 190 that is the face detection means and a second mode that uses the camera shake detection means.

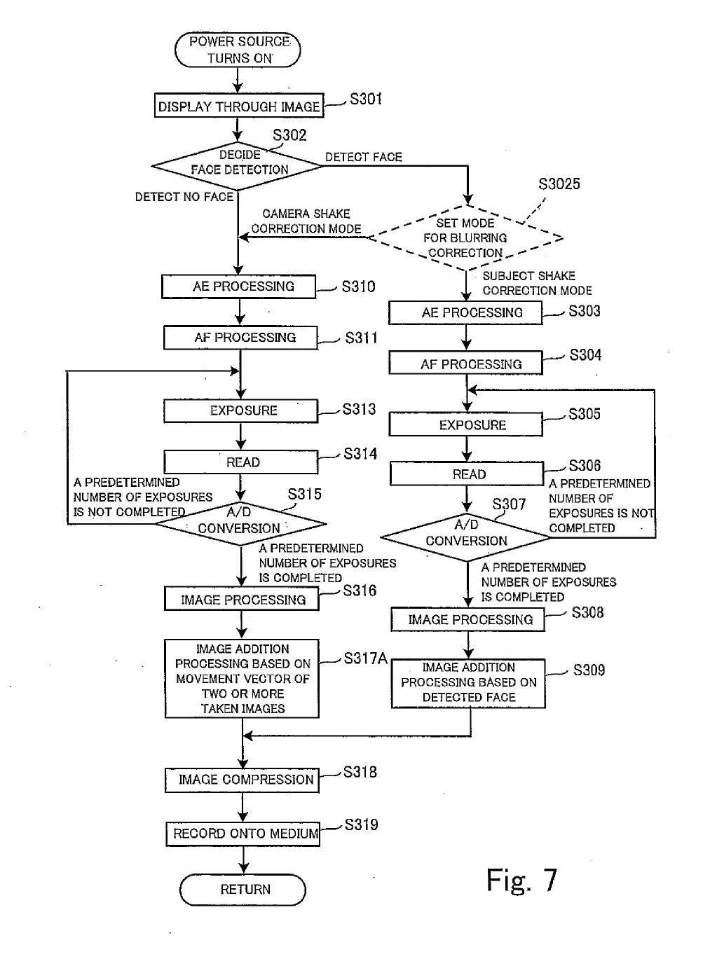

FIG. 7 is a flowchart useful for understanding another processing procedure where there is provided mode setting means which is the same as FIG. 6.

According to the processing procedure of FIG. 7, the movement vector is computed in the digital signal processing section 182 instead of the angular velocity sensor 160, so that the camera shake is corrected in accordance with the movement vector. Thus, the processing of the step S312 of FIG. 6 is omitted, and the processing of the step S317 is replaced by the processing of the step S317A which is based on the movement vector computed in the digital signal processing section 182. Processing of FIG. 7 is similar to FIG. 6 excluding these.

According to the present embodiment, the photographer selects the blurring mode between the camera shake correction mode and the subject shake correction mode by the operation. However, this structure brings about the difficulty in use somewhat. Thus, there is considered an arrangement that the camera shake correction mode is set at the scenery mode and the subject shake correction mode is set at the portrait mode.

This arrangement makes it possible to automatically discriminate whether the main subject is a person or a background in accordance with the mode set in the image taking apparatus without the photographer's consciousness, so that the blurring correction is done adaptive.

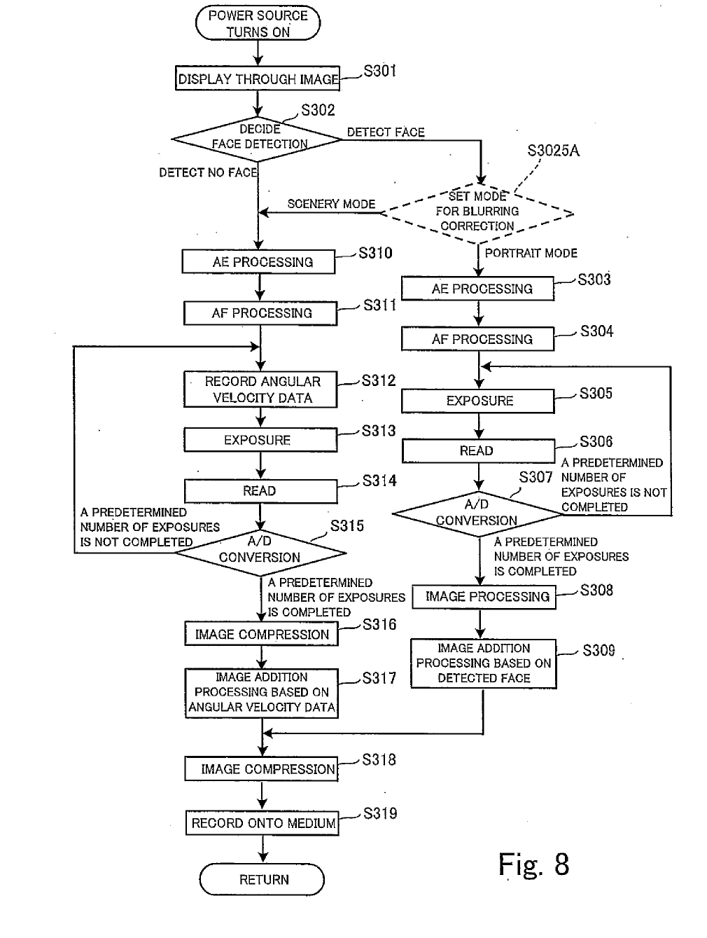

FIG. 8 is a flowchart useful for understanding processing procedure where the camera shake is corrected at the scenery mode and the subject shake is corrected at the portrait mode.

The processing procedure of FIG. 8 is identical to that of FIG. 6 excepting that the processing of the step S3025 is replaced by the processing of the step S3025A. As shown in FIG. 8, the subject shake is corrected in the portrait mode instead of the subject shake correction mode, and the camera shake is corrected in the scenery mode instead of the camera shake correction mode.

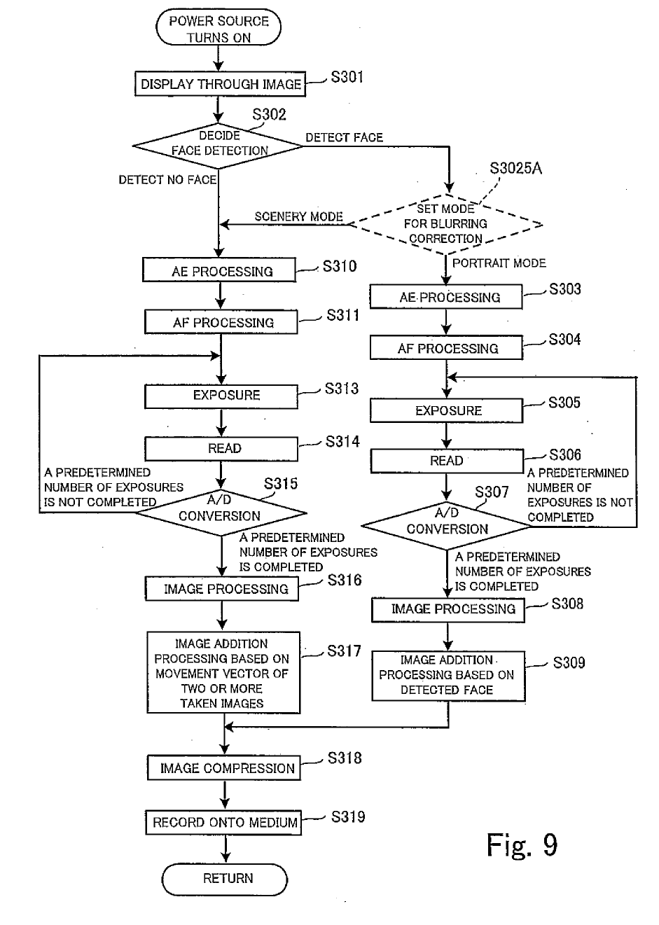

FIG. 9 is a flowchart useful for understanding another processing procedure in the same structure as FIG. 8.

The processing procedure of FIG. 9 is identical to that of FIG. 8 excepting that the processing of the step S312 of FIG. 8 is omitted, and the processing of the step S317 is replaced by the processing of the step S317A.

In the event that portrait mode is designated as mentioned above, it is more effective to provide such an arrangement that it is displayed on the display that the subject shake is corrected and notifies the photographer.

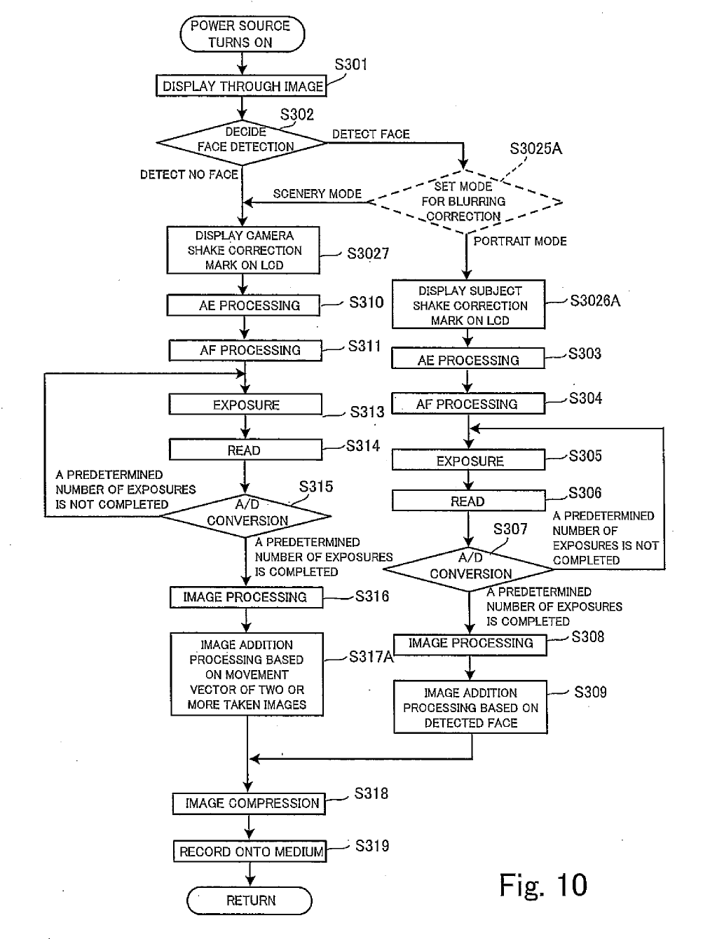

FIG. 10 is a flowchart in a structure wherein the photographer is notified of the correction mode in such a way that the image indicative of a matter that the subject shake is corrected is displayed on the display screen.

When it is decided in a step S3025A that the portrait mode is designated, a subject shake correction mark is displayed on the display screen at a step S3026A. When the scenery mode or face is not detected, a camera shake correction mark is displayed on the display screen at a step S3027.

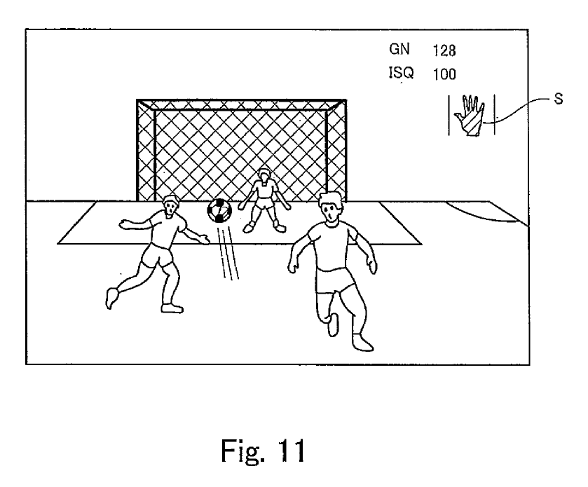

FIG. 11 is an explanatory view useful for understanding a camera shake correction mark.

As seen from FIG. 11, the photographer is notified of the effect that the camera shake correction is performed by an image S having the shape of the hand being displayed. For instance, person's shape is displayed at the subject shake. This feature makes it possible for the photographer to confirm that the mode is in the intended mode or the mode not intended by seeing the mark on the display.

It is more effective to provide such an arrangement that it is possible to display in which mode the correction was done when reproducing.

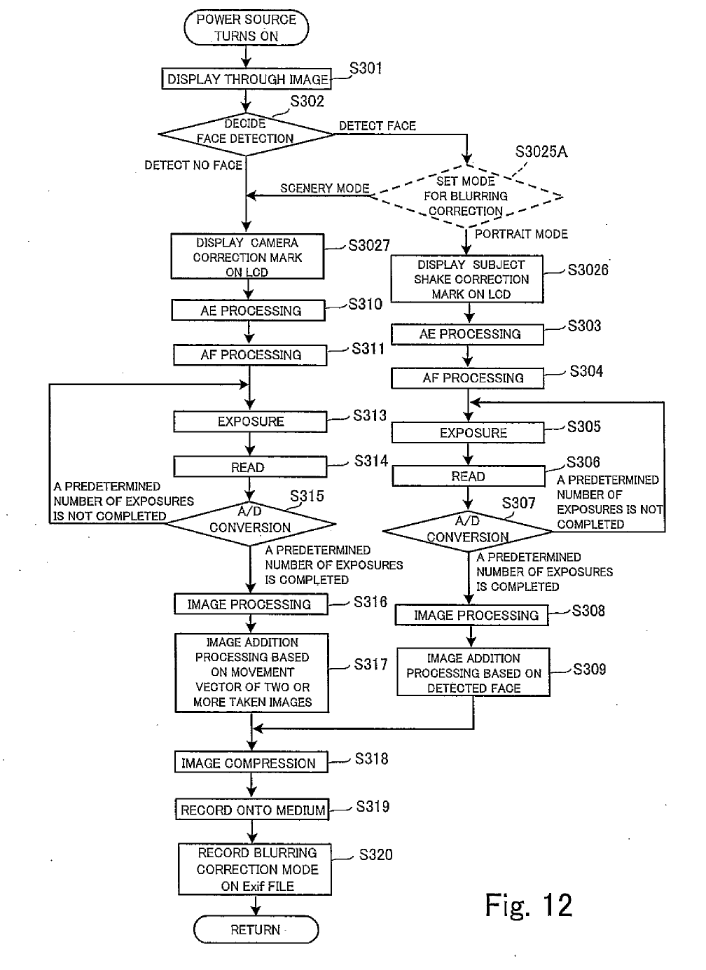

FIG. 12 is a flowchart useful for understanding processing procedure where a correction mode is recorded onto a tag area of Exif file that is an image file.

The flowchart of FIG. 12 is identical to that of FIG. 10 excepting that the processing of a step S320 is added.

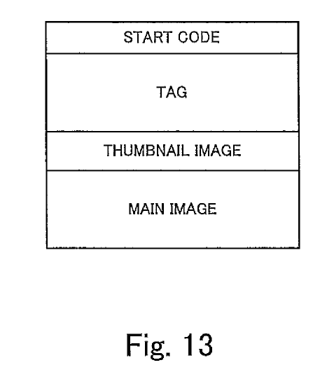

FIG. 13 is an explanatory view useful for understanding a memory allocation of Exif file.

The Exit file, which is one form of the image file, has memory areas shown in FIG. 13. The memory areas comprise a start code area, a tag area, a thumbnail area, and a main image area. Information on the main image, for instance, the photographic date is recorded in the tag area. The recording of the correction mode in the tag area makes it possible to read the correction mode from the tag area at the time of reproducing and display it on the display screen. The photographer can use information on the correction mode when seeing the image on the display and analyzing the image.

As mentioned above, according to the present invention, it is possible to implement an image taking apparatus capable of correcting the subject shake where the main subject is a person.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An image taking apparatus that images a subject on an imaging device to create an image representative of the subject, the image taking apparatus comprising:
multi-page means that performs two or more consecutive shootings to create two or more images;
piled up image creating means that creates a piled up image by piling up the images obtained by the multi-page means; and
face detection means that detects a face in each of the two or more images,
wherein the piled up image creating means performs mutually positioning of the faces detected by the face detection means in the two or more images through the two or more images, and piles up the two or more images to create the piled up image.

2. The image taking apparatus according to claim 1, further comprising camera shake detection means that detects a camera shake to create camera shake information for each of the two or more consecutive shooting by the multi-page means,
wherein when the face detection means detects no face in the two or more images, the piled up image creating means performs mutually positioning through the two or more images in accordance with the camera shake information created by the camera shake detection means, and piles up the two or more images to create the piled up image.

3. The image taking apparatus according to claim 2, wherein the camera shake detection means is an angular velocity sensor.

4. The image taking apparatus according to claim 1, further comprising movement vector computing means that computes a movement vector representative of movements of the two or more images in accordance with the two or more images,
wherein when the face detection means detects no face in the two or more images, the piled up image creating means performs mutually positioning through the two or more images in accordance with the movement vector computed by the movement vector computing means, and piles up the two or more images to create the piled up image.

5. An image taking apparatus that images a subject on an imaging device to create an image representative of the subject, the image taking apparatus comprising:
multi-page means that performs two or more consecutive shootings to create two or more images;
piled up image creating means that creates a piled up image by piling up the images obtained with the multi-page means;
face detection means that detects a face in each of the two or more images;
camera shake detection means that detects a camera shake to create camera shake information for each of the two or more consecutive shootings by the multi-page means, and
mode switching means that switches, when the piled up image creating means creates the piled up image, a mode between a first mode in which the face detection means is prioritized and a second mode in which the camera shake detection means is used,
wherein in a case the face detection means detects a face in the two or more images in the first mode, the piled up image creating means performs mutually positioning the face in each of the two or more images through the two or more images and piles up the two or more images to create the piled up image, and in a case where in the first mode the face detection means detects no face in the two or more images or in the second mode, the piled up image creating means performs mutually positioning through the two or more images in accordance with the camera shake information created by the camera shake detection means, and piles up the two or more images to create the piled up image.

6. The image taking apparatus according to claim 5, further comprising mode notification means that notifies a user of whether the image taking apparatus is currently in the first mode or the second mode.

7. The image taking apparatus according to claim 5, wherein the first mode is a camera shake correction mode for correcting a camera-shake, and the second mode is a subject shake correction mode for correcting a subject shake.

8. The image taking apparatus according to claim 5, wherein the first mode is a scenery shooting mode for taking a picture of scenery, and the second mode is a self shooting mode that takes a picture of oneself.

9. The image taking apparatus according to claim 5, wherein the camera shake detection means is an angular velocity sensor.

10. The image taking apparatus according to claim 5, wherein the camera shake detection means is a movement vector computing means.

11. An image taking apparatus that images a subject on an imaging device to create an image representative of the subject, the image taking apparatus comprising:
multi-page means that performs two or more consecutive shootings to create two or more images;
piled up image creating means that creates a piled up image by piling up the images obtained by the multi-page means;
face detection means that detects a face in each of the two or more images;
movement vector computing means that computes a movement vector representative of movements of the two or more images in accordance with said two or more images; and
mode switching means that switches, when the piled up image creating means creates the piled up image, a mode between a first mode in which the face detection means is made to give priority and a third mode in which the movement vector computing means is used,
wherein in a case the face detection means detects a face in the two or more images in the first mode, the piled up image creating means performs mutually positioning the face in each of the two or more images through the two or more images and piles up the two or more images to create the piled up image, and in a case where in the first mode the face detection means detects no face in the two or more images or in the third mode, the piled up image creating means performs mutually positioning through the two or more images in accordance with the movement vector computed by the movement vector computing means, and piles up the two or more images to create the piled up image.

12. The image taking apparatus according to claim 11, further comprising mode notification means that notifies a user of whether the image taking apparatus is currently in the first mode or the third mode.

13. The image taking apparatus according to claim 11, wherein the first mode is a camera shake correction mode for correcting a camera shake, and the third mode is a subject shake correction mode for correcting a subject shake.
